(19) United States
(12) Patent Application Publication
(10) Pub. No.: US 2026/0106193 A1
(43) Pub. Date: Apr. 16, 2026

(54) FUEL CELL SYSTEM AND METHOD FOR CONTROLLING A HEATING CURRENT FOR TEMPERATURE CONTROL OF A FUEL CELL STACK OF A FUEL CELL SYSTEM

(71) Applicant: Robert Bosch GmbH, Stuttgart (DE)

(72) Inventor: Klaus Beulich, Weil Der Stadt (DE)

(21) Appl. No.: 19/105,085

(22) PCT Filed: Sep. 7, 2023
(86) PCT No.: PCT/EP2023/074612

§ 371 Date: Feb. 20, 2025

(30) Foreign Application Priority Data
Sep. 8, 2022 (DE) 10 2022 209 345.3

(51) Int. Cl. H01M 8/04858; H01M 8/04223; H01M 8/043; H01M 8/0432; H01M 8/04537; H01M 8/04701; H02M 3/158

(52) U.S. Cl. CPC H01M 8/04917; H01M 8/04253; H01M 8/04268; H01M 8/043; H01M 8/04365; H01M 8/04559; H01M 8/04731; H01M 8/0488; H02M 3/158; H01M 2250/20

(57) ABSTRACT

The invention relates to a fuel cell system (100), wherein the fuel cell system (100) comprises a fuel cell stack (10) for generating an output voltage and a boost converter (30) for increasing the output voltage of the fuel cell stack (10), having at least one converter unit (31a, 31b, 31c, 31d), wherein the converter unit (31a, 31b, 31c, 31d) comprises a coil (33) and a controllable switch (34) for increasing the output voltage of the fuel cell stack (10), wherein the controllable switch (34) comprises a variable resistor. Furthermore, the fuel cell system (100) comprises a control apparatus (50), wherein the control apparatus is configured so as to control the controllable switch (34) of the at least one converter unit (31a, 31b, 31c, 31d) in such a way that the resistor of the controllable switch (34) of the at least one converter unit (31a, 31b, 31c, 31d) is adjusted for controlling a heating current for temperature control of the fuel cell stack (10).

### BACKGROUND

Fuel cell stacks, in particular in mobile applications, can be exposed to ambient temperatures below the freezing point. To avoid damaging the fuel cell stack during commissioning in this temperature range, the fuel cell stacks can be heated.

It is known to provide a heating phase prior to the normal operation of the fuel cell system, wherein the efficiency of the fuel cell system is disadvantageously deteriorated in this heating phase in order to increase the production of waste heat of a fuel cell stack of the fuel cell system. This waste heat can be used in order to heat up the fuel cell stack.

DE 10 2012 218 584A1 further discloses the arrangement of an additional load resistor having a fixed resistance value between the electrical contacts of a fuel cell arrangement, wherein the additional load resistor is switchable by means of a switching element at least during a heating phase of the fuel cell arrangement as a sole or at least substantially sole consumer. Disadvantageously, the current flowing through the load resistor is dependent on the fixed resistance value of the load resistor.

### SUMMARY

The present invention discloses a fuel cell system a method according to the disclosure.

Further features and details of the invention arise from the dependent claims, the description, and the drawings. In this context, features and details described in connection with the fuel cell system according to the invention clearly also apply in connection with the method according to the invention, and respectively vice versa, so that mutual reference to the individual considerations of the invention always is or can be made with respect to the disclosure.

According to a first aspect, the present invention discloses a fuel cell system, wherein the fuel cell system comprises a fuel cell stack for generating an output voltage. Furthermore, the fuel cell system comprises a boost converter for increasing and/or increasing and stabilizing the output voltage of the fuel cell stack, wherein the boost converter comprises at least one converter unit, wherein the at least one converter unit comprises at least one coil and a controllable switch for increasing the output voltage of the fuel cell stack, wherein the controllable switch comprises, or forms, or has a variable resistor or a variable resistance value, in particular a resistor which can be varied continuously at least in sections or a resistor which can be varied substantially continuously in sections. Furthermore, the fuel cell system comprises a control apparatus, wherein the control apparatus is configured so as to control or actuate at least the controllable switch of the at least one converter unit in such a way that the variable resistor or variable resistance value of the controllable switch of the at least one converter unit is adjusted for controlling, in particular below a minimum input voltage of the boost converter, a heating current for temperature control of at least the fuel cell stack.

The fuel cell stack can comprise a plurality of interconnected fuel cells for generating the output voltage.

The fuel cell system can be used, for example, in a vehicle, for example a fuel cell vehicle.

With the boost converter, the output voltage generated by the fuel cell stack can be converted and/or stabilized to a higher voltage.

In particular, the coil and controllable switch of the at least one converter unit is (electrically or electrotechnically) arranged between a first electrical contact, preferably a positive pole, of the fuel cell stack and a second electrical contact, preferably a negative pole, of the fuel cell stack. Furthermore, the at least one converter unit can comprise a free-wheel diode.

The boost converter can comprise a plurality of converter units, each having at least one coil and a controllable switch for increasing the output voltage of the fuel cell stack. In other words, the boost converter can be configured in multiple phases. Thus, the boost converter can have a good efficiency over a wide performance range, and a filtering effort can be particularly low. In the case of a plurality of converter units, the heating current for the temperature control of at least the fuel cell stack can be divided, preferably evenly divided, among the plurality of converter units. Details and/or features and/or explanations and/or embodiments mentioned for the at least one converter unit and/or a converter unit or its components can also be transferred to a further converter unit and/or the plurality of converter units, and vice versa. In particular, the coil and/or the controllable switch can be understood as components. In particular, the at least one converter unit and a further converter unit or the plurality of converter units are configured the same or substantially the same. Thus, the boost converter can be particularly simple and/or inexpensive.

The boost converter can also be understood as a DC/DC converter.

The term “wherein the controllable switch comprises a variable resistor” can also be understood to mean that the controllable switch comprises a resistor having a variable resistance value.

Preferably, the controllable switch of the at least one converter unit comprises a resistor, which can be continuously varied at least in sections, or a resistor which can be substantially continuously varied in sections. Thus, the variable resistor of the controllable switch of the at least one converter unit can be freely adjusted, and the heating current for a temperature control of at least the fuel cell stack can be particularly advantageously controlled. The range in which the controllable switch of the at least one converter unit comprises a resistor that can be varied continuously at least in sections or a resistor that can be substantially continuously varied at least in sections can be understood as the resistance variation range of the controllable switch of the at least one converter unit. In addition, the controllable switch of the at least one converter unit can comprise a blocking range and/or a passing range, wherein in particular the controllable switch comprises a resistance maximum in the blocking range and a resistance minimum in the passing range. In particular, the output voltage of the fuel cell stack is increased by means of the at least one converter unit by a (direct) oscillation, in particular repeating oscillation, of the resistor of the controllable switch of the at least one converter unit between the blocking range (resistance maximum) and the through range (resistance minimum) of the controllable switch. The resistance variation range of the controllable switch of the at least one converter unit lies in particular (in a resistance-technical sense) between the blocking range and the passing range of the controllable switch of the at least one converter unit. For example, the controllable switch can comprise a transistor, in particular a MOSFET transistor, or a thyristor, in particular a GTO transistor, having a blocking range, and a saturation range as the passing range, wherein the transistor, in particular the MOSFET transistor or a thyristor, in particular a GTO transistor, comprises a continuously variable resistance or a substantially continuously variable resistance in the linear range, at least in sections.

The variable resistor of the controllable switch of the at least one converter unit of the boost converter can be understood as an electrical resistor, in particular an ohmic resistor.

At least the controllable switch of the at least one converter unit can be controlled by the control apparatus, such that the resistor of the controllable switch or the resistance value of the controllable switch of the at least one converter unit is or can be adjusted. Thus, the heating current for temperature control of at least the fuel cell stack can be adjusted. For example, in a MOSFET transistor as a controllable switch, the control apparatus can control a gate source voltage of the MOSFET transistor in order to adjust the resistor of the controllable switch or the resistance value of the controllable switch of the at least one converter unit. The adjustment of the resistor or resistance value of the controllable switch of the at least one converter unit is in particular to be understood as a variation of the resistor or resistance value of the controllable switch, for example between at least a first resistance value and a second resistance value and/or within a resistance variation range of the controllable switch of the at least one switch unit.

In addition to the controllable switch of the at least one converter unit, a controllable switch of a further converter unit or a respective controllable switch of a plurality of further converter units can each be controlled by the control apparatus, such that the resistor of the controllable switch or the resistance value of the controllable switch of the respective converter unit is or can be adjusted, preferably independently of one another, for temperature control of at least the fuel cell stack.

In particular, the control apparatus can comprise a microcontroller at least for controlling the controllable switch of the at least one converter unit or for respectively controlling a controllable switch of a plurality of converter units of the boost converter. Thus, an additional circuitry can be omitted. Furthermore, the control apparatus can comprise a heating current distributor, wherein the heating current distributor is configured so as to calculate a respectively required target heating current for a plurality of converter units. In particular, the heating current or the target heating current can be specified or calculated in consideration of a charging current for an output capacitor of the fuel cell system or the boost converter.

Due to the fact that the control apparatus is configured so as to control at least the controllable switch of the at least one converter unit or in particular control a controllable switch of a respective converter unit of a plurality of converter units in such a way that the variable resistor of the controllable switch of the at least one converter unit or a variable resistor of the controllable switch of a respective converter unit of the plurality of converter units is or can be adjusted, an additional circuitry effort in the form of a separate switching element and a separate load resistor is not required. Furthermore, a temperature control of at least the fuel cell stack, in particular below a minimum input voltage of the boost converter, can be particularly advantageous, because the heating current is freely adjustable. In addition, even with very small output voltages of the fuel cell stack, for example upon a ramp-up of the fuel cell system, the heating current can be adjusted. As a result, the ramp-up of the fuel cell system can be kept particularly low-damage and at the same time particularly short-term.

Furthermore, the controlling of the controllable switch by the control apparatus can be understood as a control or actuation of the controllable switch by the control apparatus.

The controlling of the heating current can be a control and/or a regulation of the heating current.

It can be advantageous for a fuel cell system according to the invention when the control apparatus is configured so as to control the controllable switch of the at least one converter unit at least temporarily in an unclocked manner in order to adjust the resistor of the controllable switch for controlling the heating current for temperature control of at least the fuel cell stack. Thus, the control of the controllable switch can be particularly straightforward. The expression “controlled in an unclocked manner” is used in order to express the fact that the resistor of the controllable switch of the at least one converter unit is not (directly) oscillated, in particular repeatedly oscillated, at least temporarily, for example for at least one (1) second, between a blocking range and a passing range of the controllable switch. In particular, the control apparatus is further configured so as to control the controllable switch of the at least one converter unit at least in a first voltage range, at least temporarily in an unclocked manner. For example, the first voltage range is from 0 V(olt) to a minimum input voltage of the boost converter.

For temperature control of at least the fuel cell stack, it can be advantageous when a fuel cell system according to the present invention comprises a regulator unit for regulating the heating current to a target heating current by controlling the controllable switch of the at least one converter unit. Thus, the temperature control of at least the fuel cell stack can take place in a particularly advantageous manner. The regulator unit can comprise a current measuring unit for sensing a heating current, or a partial heating current, flowing through the controllable switch of the at least one converter unit of the boost converter. In particular, the current measuring unit can comprise at least one measuring resistor and/or an operational amplifier for sensing the heating current or partial heating current flowing through the controllable switch of the at least one converter unit of the boost converter. The current regulator unit can thus be designed particularly simply. Furthermore, the regulator unit can comprise a current regulator unit for controlling the controllable switch of the at least one converter unit or the resistor of the controllable switch of the at least one converter unit, wherein the controllable switch is controlled based in particular on the sensed heating current or partial heating current and a specified or specifiable target heating current. In particular, the current regulator unit can comprise an operational amplifier or resistor of the controllable switch of the at least one converter unit. The current regulator unit can thus be designed particularly simply. The target heating current can be specified, for example, by an operating system.

It can be advantageous when, in a fuel cell system according to the invention, the controllable switch of the at least one converter unit with the variable resistor is a transistor, in particular a MOSFET transistor, or a thyristor, in particular a GTO thyristor. The controllable switch can thus be designed particularly simply.

It can be advantageous when, in a fuel cell system according to the present invention, the control apparatus is further configured so as to control in a clocked manner at least temporarily the controllable switch of the at least one converter unit, in particular between a passing state and a blocking state of the controllable switch, in order to increase the output voltage of the fuel cell stack and/or to control the heating current for temperature control of at least the fuel cell stack. Thus, the fuel cell system can be designed particularly simply. The phrase “controlled in a clocked manner” is used in order to express the fact that the resistor of the controllable switch of the at least one converter unit is (directly) oscillated, in particular repeatedly oscillated, between a blocking range, in particular a maximum resistance, and a passing range, in particular a minimum resistance, of the controllable switch, in order to at least increase the output voltage of the fuel cell stack (using the coil of the at least one converter unit). In particular, the control apparatus is further configured so as to control the controllable switch of the at least one converter unit at least in a second voltage range that is different from the first voltage range, at least temporarily in a clocked manner. The second voltage range is, for example, from a minimum input voltage of the boost converter to an upper voltage limit.

It can be advantageous when, in a fuel cell system according to the present invention, the boost converter comprises at least one further converter unit having at least one coil and a controllable switch for increasing the output voltage of the fuel cell stack, wherein the control apparatus is configured so as to control the controllable switch of the at least one converter unit and the controllable switch of the at least one further converter unit independently of one another, in particular for controlling the heating current for temperature control of at least the fuel cell stack. With the at least one further converter unit, the boost converter can have a good efficiency over a wide performance range, and a filtering effort can be particularly low. Advantageously, due to the independent controlling of the controllable switch of the at least one converter unit and the controllable switch of the at least one further converter unit, the controllable switch of the at least one converter unit can be transitioned from a continuous operation into a clock operation, and the transition of the controllable switch of the at least one further converter unit from continuous operation into clock operation can occur with a time delay. A clock operation of a controllable switch of a converter unit of the boost converter of the fuel cell stack is in particular to be understood as a clocked operation of the controllable switch; e.g. the resistor of the controllable switch of the at least one converter unit is (directly) oscillated, in particular repeatedly oscillated, between a blocking range, in particular a maximum resistance, and a passing range, in particular a minimum resistance, of the controllable switch by means of the control apparatus in order to at least increase the output voltage of the fuel cell stack (using the coil of the at least one converter unit). Continuous operation of a controllable switch of a converter unit of the boost converter of the fuel cell stack is in particular to be understood as an unclocked operation of the controllable switch. In particular, in the continuous operation of the controllable switch of the converter unit, the resistor of the controllable switch lies within a resistance variation range of the controllable switch. Continuous operation can also be understood as linear operation.

According to a second aspect, the present invention discloses a method for controlling a heating current for temperature control of at least one fuel cell stack of a fuel cell system, wherein the fuel cell system is configured according to the invention. The method comprises, as one step, activating the fuel cell stack for generating an output voltage on the fuel cell stack. Furthermore, as one step, the method comprises controlling, in particular an unclocked controlling, of the controllable switch of the at least one converter unit of the boost converter of the fuel cell system in such a way that the resistor of the controllable switch of the at least one converter unit is adjusted for controlling the heating current for temperature control of at least the fuel cell stack.

The method steps described above and below can be performed individually, together, once, several times, in parallel, and/or consecutively in any order, provided that doing so is technically feasible.

In particular, prior to activating the fuel cell stack, the fuel cell stack is deactivated, i.e. no supply of hydrogen and oxygen takes place, for example. In the deactivated state, in particular, an open-circuit voltage is shorted as the output voltage to terminals of the fuel cell stack. The short circuit can occur, for example, by means of a switchable discharge resistor or the controllable switch of the at least one converter unit of the boost converter. In order to reduce the open-circuit current draw, it can be sufficient to control only one controllable switch.

In particular, for activating the fuel cell stack, a reducing agent and an oxidizing agent are supplied to the fuel cell stack and, if necessary, a short circuit is lifted at the terminals of the fuel cell stack.

For temperature control of at least the fuel cell stack, it can be advantageous when a method according to the present invention comprises a regulator unit, wherein the heating current is regulated to a target heating current by means of the regulator unit by controlling the controllable switch of the at least one converter unit. Thus, the temperature control of the fuel cell stack can take place in a particularly advantageous manner.

It can be advantageous when, in a method according to the invention, the controllable switch of the at least one converter unit is controlled at least temporarily in an unclocked manner, i.e. operated in continuous operation, by the control apparatus in order to adjust the resistor of the controllable switch for controlling the heating current for temperature control of at least the fuel cell stack, and wherein, chronologically after the unclocked controlling of the controllable switch, at least temporarily the controllable switch of the at least one converter unit is controlled by the control apparatus in a clocked manner, i.e. operated in clock operation, in such a way that at least the output voltage of the fuel cell stack is increased. Thus, in a first voltage range, e.g. from 0 V(olt) to a minimum input voltage of the boost converter, the controllable switch of the at least one converter unit for a temperature control phase, in particular the heating phase, of the fuel cell system can be used. Furthermore, in a second voltage range, e.g. from the minimum input voltage of the boost converter to a voltage upper limit, the controllable switch of the at least one converter unit can be used for increasing and/or stabilizing the output voltage of the boost converter.

It can be advantageous when, in a method according to the invention, the controllable switch of the at least one converter unit is controlled in a clocked manner by the control apparatus when the output voltage of the fuel cell stack exceeds a certain voltage threshold value and/or the fuel cell stack exceeds a certain temperature threshold value. For example, the determined voltage threshold can be a minimum input voltage of the boost converter. The minimum input voltage of the boost converter is in particular a voltage from which the boost converter can begin the function of increasing the voltage, in particular for regulation reasons.

It can be advantageous when, in a method according to the invention, the fuel cell system comprises at least one further converter unit having at least one coil and a controllable switch for increasing the output voltage of the fuel cell stack, wherein the respective controllable switch controls the at least two converter units of the boost converter of the fuel cell system, in particular independently of one another, in such a way that the resistor of the controllable switch of the respective converter unit is adjusted for controlling the heating current for temperature control of at least the fuel cell stack. By means of the further converter unit having the controllable switch, the heating current can be divided and, for example from an output voltage of the fuel cell system, one of the two controllable switches can be used for increasing the output voltage, while the controllable switch of the further converter unit is still used for temperature control of at least the fuel cell stack. It can be advantageous when, in a method according to the invention, the controllable switch of the at least one converter unit is operated continuously or in linear operation, and, with a time delay, the controllable switch of the at least one further converter unit is transitioned from continuous operation or linear operation into clock operation. Thus, advantageously, one controllable switch after the other can be transitioned from continuous operation or linear operation into clock operation, and interferences due to the simultaneous transition of a plurality of controllable switches can be prevented in an improved manner. The (respective) transition from continuous operation into clock operation can in particular be a transition such that the controllable switch is controlled or operated in a clocked manner with a slowly increasing duty cycle (so-called “soft start”).

It can be advantageous when, in a method according to the invention, for controlling the heating current for temperature control of at least the fuel cell stack, the resistor of the controllable switch of the at least one converter unit is adjusted as a function of a voltage, in particular an output voltage of the fuel cell stack and/or a minimum input voltage of the boost converter, and/or a temperature, in particular a temperature of the fuel cell stack, and/or an anode gas quantity and/or a cathode gas quantity and/or an aging of the fuel cell system. Thus, the temperature control of at least the fuel cell stack can take place in a particularly advantageous manner.

The method according to the second aspect of the invention thus has the same advantages as have already been described for the fuel cell system according to the first aspect of the invention.

Further measures improving the invention arise from the following description of a few exemplary embodiments of the invention, which are schematically represented in the figures. All of the features and/or advantages arising from the claims, description, or drawings, including structural details, spatial arrangements, and method steps, can be essential to the invention both by themselves and in the various combinations. It should be noted that the figures have only a descriptive character and are not intended to limit the invention in any way.

### BRIEF DESCRIPTION OF THE DRAWINGS

Schematically shown are:

FIG. 1 A schematic diagram of a fuel cell system, and

FIG. 2 a method, and

FIG. 3 a method.

### DETAILED DESCRIPTION

In the following figures, identical reference numbers are used for identical technical features, even in different exemplary embodiments.

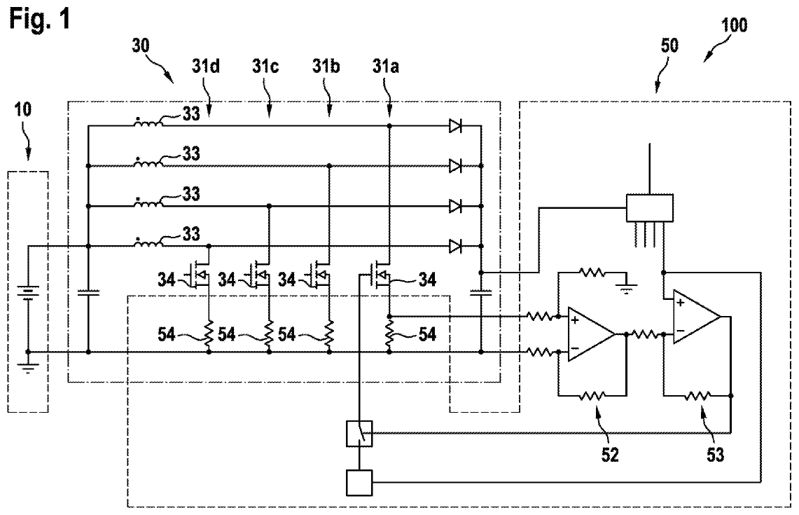

FIG. 1 discloses a schematic diagram of a fuel cell system 100. The fuel cell system 100 comprises a fuel cell stack 10 for generating an output voltage. Furthermore, the fuel cell system 100 comprises a boost converter 30 for increasing the output voltage of the fuel cell stack 10, wherein the boost converter 30 comprises at least one converter unit 31a, wherein the at least one converter unit 31a comprises at least one coil 33 and a controllable switch 34 for increasing the output voltage of the fuel cell stack 10, wherein the controllable switch 34 comprises a variable resistor, in particular a resistor which can be varied continuously at least in sections or a resistor which can be varied substantially continuously in sections. Furthermore, the fuel cell system 100 comprises a control apparatus 50, wherein the control apparatus is configured so as to control at least the controllable switch 34 of the at least one converter unit 31a in such a way that the variable resistor of the controllable switch 34 of the at least one converter unit 31a is adjusted for controlling a heating current for temperature control of at least the fuel cell stack 10. Advantageously, the boost converter 30 shown in FIG. 1 optionally, i.e. additionally, comprises three further converter units 31b, 31c, and 31d, each having a coil 33 and a controllable switch 34. Each of the converter units 31a, 31b, 31c, 31d further additionally comprises a free-wheel diode. The controllable switches 34 of the four converter units 31a, 31b, 31c, 31d can each be a transistor having a blocking range, a linear range as a resistance variation range, and a saturation range as the passing range. Furthermore, it is contemplated that the controllable switch 34 of the at least one converter unit 31a and the controllable switches 34 of the further converter units 31b, 31c, 31d can be actuated independently of one another. Thus, the controllable switches 34 can be successively converted into a clocked operation for increasing the output voltage of the fuel cell stack 10 using the respective coil 33.

Advantageously, in the fuel cell system 100 shown in FIG. 1, the control apparatus 50 is optionally, i.e. additionally, configured so as to control the controllable switch 34 of the at least one converter unit 31a, 31b, 31c, 31d at least temporarily in an unclocked manner in order to adjust the resistor of the controllable switch 34 for controlling the heating current for temperature control of at least the fuel cell stack 10, e.g. in a heating phase of the fuel cell system 100.

Advantageously, the control apparatus 50 shown in FIG. 1 optionally, i.e. additionally, comprises a regulator unit 51 for regulating the heating current for temperature control of at least the fuel cell stack 10 to a target heating current by controlling the controllable switch 34 of the at least one converter unit 31a, 31b, 31c, 31d. The regulator unit 51 can comprise a current measuring unit 52 for sensing a heating current, or a partial heating current, flowing through the controllable switch 34 of the at least one converter unit 31a of the boost converter 30. In particular, the current measuring unit 52 can comprise at least one measuring resistor 54 and/or an operational amplifier for sensing the heating current or partial heating current flowing through the controllable switch of the at least one converter unit of the boost converter. Furthermore, the regulator unit 51 can comprise a current regulator unit 53 for controlling the controllable switch 34 of the at least one converter unit 31a or the resistor of the controllable switch 34 of the at least one converter unit 31a, respectively.

Advantageously, in the fuel cell system 100 shown in FIG. 1, the control apparatus 50 is optionally, i.e. additionally, configured so as to control in a clocked manner at least temporarily the controllable switch 34 of the at least one converter unit 31a, 31b, 31c, 31d, in particular between a passing state and a blocking state of the controllable switch 34, in order to increase the output voltage of the fuel cell stack 10 and/or to control the heating current for temperature control of at least the fuel cell stack 10. Thus, for both an unclocked control as well as a clocked control, the control apparatus 50 can serve at least the controllable switch 34 of the at least one converter unit 31a and additionally the controllable switch 34 of the further converter units 31b, 31c, 31d.

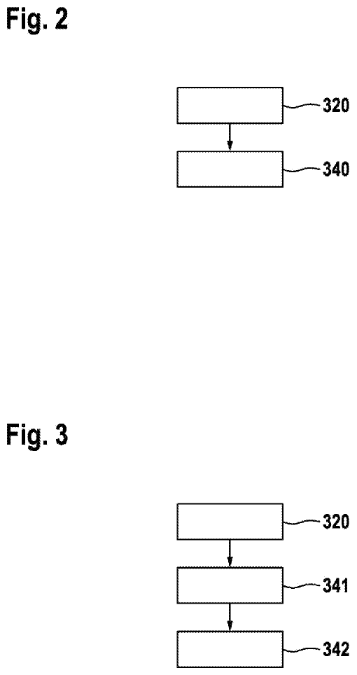

FIG. 2 discloses a method for controlling a heating current for temperature control of at least one fuel cell stack 10 of a fuel cell system 100, as described for example for FIG. 1. Advantageously, the fuel cell system 100 is configured according to the invention. The method comprises, as a first step, activating 320 the fuel cell stack 10 in order to generate an output voltage on the fuel cell stack 10. Furthermore, as a further step, the method comprises controlling 340, in particular an at least temporarily unclocked controlling 340, of the controllable switch 34 of the at least one converter unit 31a, 31b, 31c, 31d of the boost converter 30 of the fuel cell system 100 in such a way that the resistor of the controllable switch 34 of the at least one converter unit 31a, 31b, 31c, 31d is adjusted for controlling, and in particular regulating, the heating current for temperature control of at least the fuel cell stack 10. Furthermore, it is contemplated that, for controlling the heating current for temperature control of at least the fuel cell stack 10, the resistor of the controllable switch 34 of the at least one converter unit 31a, 31b, 31c, 31d is adjusted as a function of a voltage and/or a temperature and/or an anode gas quantity and/or a cathode gas quantity and/or an aging of the fuel cell system 100. Furthermore, in the case of a plurality of converter units 31a, 31b, 31d, 31d (see, for example, FIG. 1), the respective controllable switch 34 of the plurality of converter units 31a, 31b, 31c, 31d of the boost converter 30 of the fuel cell system 100 can be controlled independently of one another. It is further contemplated in the case of a plurality of converter units 31a, 31b, 31c, 31d that first the controllable switch 34 of the at least one converter unit 31a is transitioned from a continuous operation into a clock operation and, with a time delay, the further controllable switches 34 of the further converter units 31b, 31c, 31d are successively transitioned from continuous operation into clock operation.

FIG. 3 discloses a method for controlling a heating current for temperature control of at least one fuel cell stack 10 of a fuel cell system 100, as already described in particular for FIG. 2. In particular, the fuel cell system 100 is a fuel cell system 100 according to the present invention. As one step, the method comprises activating 320 the fuel cell stack 10 in order to generate an output voltage on the fuel cell stack 10. Furthermore, in a further step of the method, the controllable switch 34 of the at least one converter unit 31a, 31b, 31c, 31d is controlled 341 at least temporarily in an unclocked manner by the control apparatus 50 in order to adjust the resistor of the controllable switch 34 for controlling the heating current for temperature control of at least the fuel cell stack 10. In a further step of the method, chronologically after the unclocked controlling 341 of the controllable switch 34, at least temporarily the controllable switch 34 of the at least one converter unit 31a, 31b, 31c, 31d is controlled 342 by the control apparatus 50 in a clocked manner in such a way that at least the output voltage of the fuel cell stack 10 is increased.

1. A fuel cell system (100), wherein the fuel cell system (100) comprises:
a fuel cell stack (10) for generating an output voltage,
a boost converter (30) for increasing the output voltage of the fuel cell stack (10), wherein the boost converter (30) comprises at least one converter unit (31a, 31b, 31c, 31d), wherein the at least one converter unit (31a, 31b, 31c, 31d) comprises at least one coil (33) and a controllable switch (34) for increasing the output voltage of the fuel cell stack (10), wherein the controllable switch (34) comprises a variable resistor,
a control apparatus (50), wherein the control apparatus is configured so as to control at least the controllable switch (34) of the at least one converter unit (31a, 31b, 31c, 31d) in such a way that the variable resistor of the controllable switch (34) of the at least one converter unit (31a, 31b, 31c, 31d) is adjusted for controlling a heating current for temperature control of at least the fuel cell stack (10).

2. The fuel cell system (100) according to claim 1, wherein
the control apparatus (50) is configured to control the controllable switch (34) of the at least one converter unit (31a, 31b, 31c, 31d) in an unclocked manner to adjust the resistor of the controllable switch (34) for controlling the heating current for temperature control of at least the fuel cell stack (10).

3. The fuel cell system (100) according to claim 1,
wherein
the control apparatus (50) comprises a regulator unit (51) for regulating the heating current for temperature control of at least the fuel cell stack (10) to a target heating current by controlling the controllable switch (34) of the at least one converter unit (31a, 31b, 31c, 31d).

4. The fuel cell system (100) according to claim 1,
wherein
the controllable switch (34) of the at least one converter unit (31a, 31b, 31c, 31d) having the variable resistor is a transistor, or a thyristor.

5. The fuel cell system (100) according to claim 1,
wherein
the control apparatus (50) is further configured to control in a clocked manner the controllable switch (34) of the at least one converter unit (31a, 31b, 31c, 31d) to increase the output voltage of the fuel cell stack (10) and/or to control the heating current for temperature control of at least the fuel cell stack (10).

6. The fuel cell system (100) according to claim 1,
wherein
the boost converter (30) comprises at least one further converter unit (31a, 31b, 31c, 31d) having at least one coil (33) and a controllable switch (34) for increasing the output voltage of the fuel cell stack (10), wherein the control apparatus (50) is configured so as to control the controllable switch (34) of the at least one converter unit (31a, 31b, 31c, 31d) and the controllable switch (34) of the at least one further converter unit (31a, 31b, 31c, 31d) independently of one another.

7. A method for controlling a heating current for temperature control of at least one fuel cell stack (10) of a fuel cell system (100), wherein the fuel cell system (100) is configured according to claim wherein the method comprises:
activating (320) the fuel cell stack (10) for generating an output voltage on the fuel cell stack (10),
controlling (340), of the controllable switch (34) of the at least one converter unit (31a, 31b, 31c, 31d) of the boost converter (30) of the fuel cell system (100) in such a way that the resistor of the controllable switch (34) of the at least one converter unit (31a, 31b, 31c, 31d) is adjusted for controlling the heating current for temperature control of at least the fuel cell stack (10).

8. The method according to claim 7,
wherein
the control apparatus (50) comprises a regulator unit (51), wherein the heating current for temperature control of at least the fuel cell stack (10) by means of the regulator unit (51) is regulated to a target heating current by controlling (340) the controllable switch (34) of the at least one converter unit (31a, 31b, 31c, 31d).

9. The method according to claim 7,
wherein
the controllable switch (34) of the at least one converter unit (31a, 31b, 31c, 31d) is controlled (341) in an unclocked manner by the control apparatus (50) in order to adjust the resistor of the controllable switch (34) for controlling the heating current for temperature control of at least the fuel cell stack (10), and wherein, chronologically after the unclocked controlling (341) of the controllable switch (34), the controllable switch (34) of the at least one converter unit (31a, 31b, 31c, 31d) is controlled (342) by the control apparatus (50) in a clocked manner in such a way that at least the output voltage of the fuel cell stack (10) is increased.

10. The method according to claim 9,
wherein
the controllable switch (34) of the at least one converter unit (31a, 31b, 31c, 31d) is controlled (342) in a clocked manner by the control apparatus (50) when the output voltage of the fuel cell stack (10) exceeds a certain voltage threshold value and/or the fuel cell stack exceeds a certain temperature threshold value.

11. The method according to claim 7,
wherein
the fuel cell system (10) comprises at least one further converter unit (31a, 32a, 33a, 34a) having at least one coil (33) and a controllable switch (34) for increasing the output voltage of the fuel cell stack (10), wherein the respective controllable switch (34) of the at least two converter units (31a, 31b, 31c, 31d) of the boost converter (30) of the fuel cell system (100) is controlled in such a way that the resistor of the controllable switch (34) of the respective converter unit (31a, 31b, 31c, 31d) is adjusted for controlling the heating current for temperature control of at least the fuel cell stack (10).

12. The method according to claim 11,
wherein
the controllable switch (34) of the at least one converter unit (31a, 31b, 31c, 31d) is converted from a continuous operation into a clock operation, and the controllable switch (34) of the at least one further converter unit (31a, 31b, 31c, 31d) is transitioned from the continuous operation into clock operation with a time delay.

13. The method according to claim 7,
wherein
for controlling the heating current for temperature control of at least the fuel cell stack (10), the resistor of the controllable switch (34) of the at least one converter unit (31a, 31b, 31c, 31d) is adjusted as a function of a voltage and/or a temperature and/or an anode gas quantity and/or a cathode gas quantity and/or an aging of the fuel cell system.
